(19) United States
(12) Patent Application Publication
(10) Pub. No.: US 2010/0181814 A1
(43) Pub. Date: Jul. 22, 2010

(54) CONTROL DEVICE FOR A VEHICLE SEAT

(76) Inventors: Jürgen Lachenmann, Nurtingen (DE); Hans Peter Lipp, Teck (DE)

Correspondence Address: MCGLEW & TUTTLE, PC, P.O. BOX 9227, SCARBOROUGH STATION, SCARBOROUGH, NY, 10510-9227, US

(21) Appl. No.: 12/690,425

(22) Filed: Jan. 20, 2010

(30) Foreign Application Priority Data
Jan. 22, 2009 (DE) 10 2009 005 674.2

(51) Int. Cl. B60N 2/44; G05D 3/00

(52) U.S. Cl. 297/217.4; 701/49; 297/217.1

(57) ABSTRACT

A control system for a vehicle seat (1) is provided with an acoustic switching element (11) for selecting a certain setting device (5) or another function and at least one manual control element (12) for actuating a motor drive (M) of the selected setting device or for executing another selected function. The vehicle seat (1) has one or more settable seat components (3) and the setting device (5) for setting the seat components (3), with at least one control element (11, 12), which can be operated by the occupant of the vehicle seat (1) for selecting and/or executing functions. Each setting device (5) provided has a motor drive (M). The motor drives (M) are connected to the control device (7).

### CROSS REFERENCE TO RELATED APPLICATIONS

This application claims the benefit of priority under 35 U.S.C. §119 of German Patent Application DE 10 2008 005 674.2 filed Jan. 22, 2009, the entire contents of which are incorporated herein by reference.

### FIELD OF THE INVENTION

The present invention pertains to a control device for a vehicle seat with one or more satiable seat components and a setting means for setting the seat components.

### BACKGROUND OF THE INVENTION

Control devices for vehicle seats are known, which have a plurality of manual control elements, for example, keys, wheels or joysticks, and by means of which a function, especially a setting means, can be selected and subsequently actuated in order to set the associated vehicle seat. Control devices of the type mentioned in the introduction, which have an acoustic switching element, which is designed as a speech recognition system and by means of which the functions can be selected and executed, are known from DE 199 07 811 C2 and DE 197 35 504 A1. These control devices have the drawback that execution of a function cannot be embodied in smaller steps, for example, the longitudinal setting of a seat, cannot be embodied in smaller steps.

### SUMMARY OF THE INVENTION

The basic object of the present invention is to improve a control device of the type mentioned in the introduction.

According to the invention, a vehicle seat with one or more settable seat components is provided with a control having a control device controlling one or more setting means for setting a state of the seat components. Each setting means has a motor drive connected to the control device. The motor drives set the state of said seat components. An acoustic control element is connected to the control device for operation by an occupant of the vehicle seat and for selecting a certain setting means or selecting another function. A manual control element is also connected to the control device for operation by an occupant of the vehicle seat for actuating the motor drive of the selected setting means and for executing another function selected.

The combination of an acoustic switching element for selecting a function, i.e., the selection of a setting means or of another function, and of a manual switching element for actuating the setting means or for executing the additional function offers both the advantage of rapid selection from among a plurality of functions and the advantage of accurate actuation of the setting means, which permits even minute corrections of the setting without iteration.

In addition, safety is increased, because each setting or other function except for the acoustic selection (by means of the acoustic control element) also requires manual operation (by means of the manual control element). Foreign acoustic signals or malfunctions due to electromagnetic noise fields can thus be prevented.

The short-circuiting of the motor drives in the resting state, i.e., that both inputs carry the same driving voltage potential (preferably ground or “−”), has the advantage that the motor drive has a braking action, i.e., it offers a braking torque against any torques introduced from the setting means.

The present invention will be explained in more detail below on the basis of the exemplary embodiments shown in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic block diagram of an exemplary embodiment according to the invention;

FIG. 2 is another block diagram of the exemplary embodiment; and

FIG. 3 is a schematic view of a vehicle seat according to the invention.

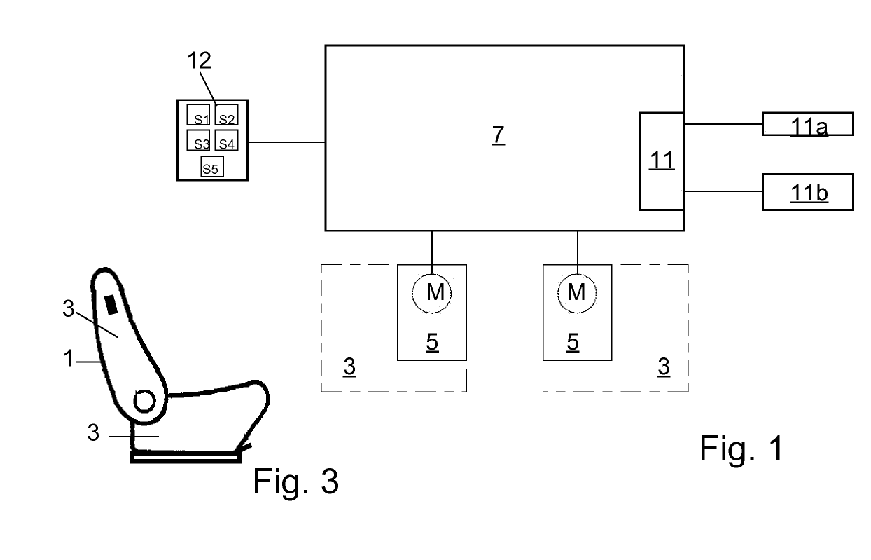

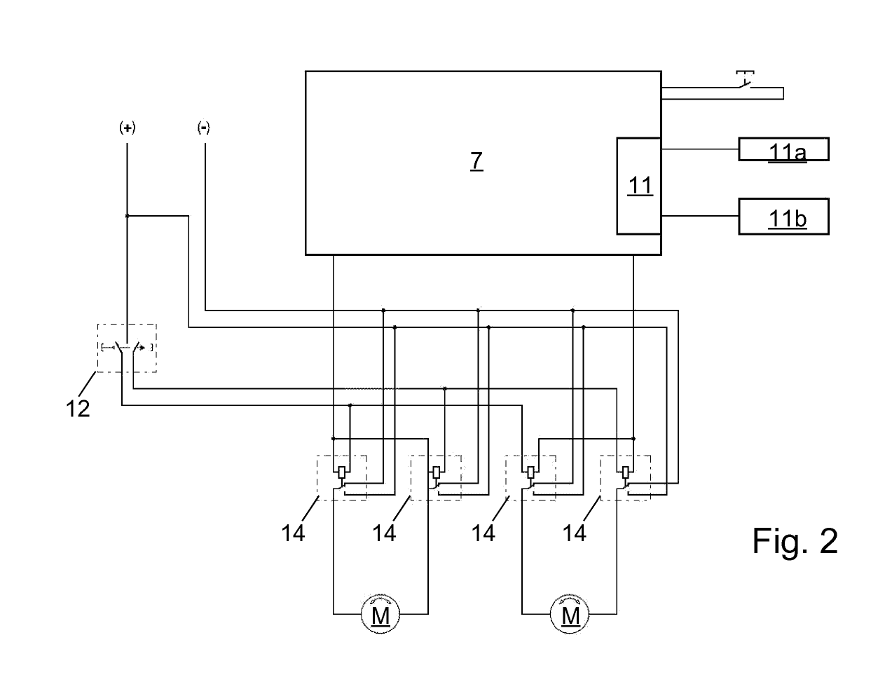

### DESCRIPTION OF THE PREFERRED EMBODIMENTS

Referring to the drawings in particular, a vehicle seat 1 for a motor vehicle has seat components 3 (cushion, backrest, headrest, lateral cheeks, etc.), which can be set by means of setting devices, hereinafter called setting means 5, and may have, for example, different relative positions and/or inclinations. Besides the possibilities of setting by means of the setting means 5, the vehicle seat may also have other executable functions, for example, the switching on or off of a seat air conditioner. On the whole, at least two functions are provided. The seat components 3 may also have each a plurality of setting possibilities (states), so that a plurality of setting means 5 may also be associated with them. A (common) control device 7, which can be operated by the occupant of the vehicle seat 1, is provided for actuating the setting means 5. The occupant can thus adapt the vehicle seat 1 corresponding to his wishes.

Based on the basic principle, each setting means 5 has, besides a mechanical component, for example, a gear mechanism, a motor drive M, preferably an electric motor, by means of which the mechanical component can be driven. The control device 7 has an acoustic control element 11 and a manual control element 12. The motor drives M are connected to the control device 7 and are actuated by it, in this case by means of two relays 14 each, because the setting means 5 usually have two setting directions. A function, e.g., an executable function, can be selected by means of the acoustic control element 11, or a certain setting means 5 (i.e., the corresponding seat component 3) can be selected. The motor drive M of said setting means is then actuated by means of the manual control element 12.

More precisely, the two relays 14 of each motor drive M are switched at first such that both inputs of the motor drive M carry the same driving voltage potential (for example, “−”). A certain setting means 5 is selected by means of the acoustic control element 11. The control device 7 then applies a control voltage potential to one winding end of the two relays 14 of the motor drive M of the selected setting means 5. The complementary control voltage potential (which is, for example, equal to the complementary driving voltage potential) is applied to the other winding end of exactly one relay 14 by means of the (manual) actuation of the manual control element 12. This relay 14 picks up and applies the complementary driving voltage potential (i.e., “+”) to the associated input of the motor drive M, as a result of which the motor drive M will move. The setting means 5 is moving in the setting direction that is associated with the switched relay 14. If the desired setting of the vehicle seat 1 is obtained, the manual control element 12 is separated from the motor drive 5, i.e., relay 14 opens, so that the motor drive M stops.

The acoustic switching element 11 in this exemplary embodiment is a speech recognition system, comprising hardware (microphone 11a, loudspeaker 11b, optionally additional electronic units) and software (speech recognition software and optionally additional control software). The control device 7 usually has a housing with motherboard, processor, memory and various interfaces, so that a large part of the software (and optionally of the hardware) of the acoustic switching element 11 may be integrated in the control device 7.

The manual switching element 12 is preferably designed as a keyboard, but it may also be a touchscreen, wheel, joystick or another lever. The manual switching element 12 usually has two operating possibilities, i.e., for example, two keys or two rotating or pivoting means of an operating element, because the setting means 5 usually have two setting directions. Two control keys (S1, S2), for example, “scroll down” and “scroll up,” the two keys (S3, S4) of the manual switching element 12 and an auxiliary key (S5) are arranged in the same keyboard in this exemplary embodiment. The keys 51, S2 and S5 likewise belong to the control device 7. The specified areas should be designed as keys in case of a touchscreen.

The mode of operation of the present exemplary embodiment will be described below.

The control device 7 of the vehicle seat 1 is activated with the ignition signal, but the acoustic switching element 11 is not automatically activated. The preset function, called “stand-by” function here, i.e., the preselection of a setting means 5, is the setting of the inclination of the backrest. If one of the two keys S3, S4 of the manual control element 12 is now pressed (key signal), the setting means 5 for the backrest inclination is driven; for example, the backrest is pivoted forwards or backwards.

After pressing one of the two control keys S1, S2 once, the acoustic switching element 11 is activated. If there is no speech command within 5 seconds, the acoustic switching element 11 will again become inactive. If a speech command is identified, the corresponding function is selected immediately, i.e., the corresponding setting means 5 is selected. The selected function can be executed with the two keys S3, S4 of the manual control element 12, i.e., the associated setting means 5 can be operated, for example, driven in the forward or backward direction. Functions and settings that cannot be checked by the occupant immediately, for example, the intensity of seat heating or of the seat fan, can be acoustically acknowledged by the control device 7, for example, by naming the function and the current intensity level. If there is no further key signal or another speech command within one minute, the control device 7 returns to the “stand-by” function.

The acoustic switching element 11 is activated by pressing one of the two control keys 51, S2 twice (key signal), and the control device 7 executes a program, which follows a manual pressing of all the available functions, beginning with the “stand-by” function. The function that is the next function in the forward or backward direction is selected by each additional pressing of the control keys S1, S2. A speech comment starts about 300 msec after the key signal and is interrupted with each new key signal or speech command. The speech command has priority over the key signals. The selected function can be executed, i.e., the associated setting means 5 can be operated, with the two keys S3, S4 of the manual control element 12. If no key is pressed or there is no speech command any more within one minute, the control device 7 returns to the “stand-by” function.

By pressing the auxiliary key S5 (key signal), introduction into the operation of the control device 7 is started (“Intro” program). This introduction is divided, for example, into three blocks and can be shortened with the auxiliary key S5, so that it is possible—for remembering—to jump specifically to the enumeration of the functions. In addition, it is possible to select between a speech comment and a beep tone for acoustic acknowledgment as well as between different languages. The “Intro” program can be interrupted at any time with the control keys S1, S2.

Besides the setting of the backrest inclination as a “stand-by” function, it is also possible to rapidly select the longitudinal setting of a seat as a function, for example, by pressing one of the two control keys S1, S2 three times.

Control device 7 preferably also has a memory function, according to which the settings of the vehicle seat 1 by means of a speech command or a key signal are stored, optionally under one or more numbers, which can in turn be identified by a speech command or a key signal within 5 seconds. The settings being stored can be polled as a whole or individually, for example, by pressing the keys S3, S4 of the manual switching element 12 until a beep tone acknowledges that the stored setting has been reached.

Furthermore, a diagnosis of the vehicle seat 1 by the control device 7 can be requested by means of the acoustic switching element 11. This can be used both by the occupant when a problem occurs or at random during the final inspection in the factory.

While specific embodiments of the invention have been described in detail to illustrate the application of the principles of the invention, it will be understood that the invention may be embodied otherwise without departing from such principles.

What is claimed is:

1. A vehicle seat control system for a vehicle seat having one or more settable seat components, the control system comprising:
a control device;
a setting means for setting said seat components wherein each setting means has a motor drive connected to said control device;
an acoustic control element connected to said control device for acoustic operation by an occupant of the vehicle seat and for selecting a certain setting means or selecting another function; and
a manual control element connected to said control device for manual operation by an occupant of the vehicle seat and for actuating the motor drive of the selected setting means or for executing said another selected function.

2. A control system in accordance with claim 1, wherein said acoustic control element is designed as a speech recognition system, which receives and recognizes speech commands.

3. A control system in accordance with claim 2, wherein said acoustic control element acoustically acknowledges the speech commands received.

4. A control system in accordance with claim 2, wherein a large part of software and optionally of hardware of said acoustic switching element is integrated in said control device.

5. A control system in accordance with claim 1, wherein said manual control element is designed as a keyboard comprising two keys.

6. A control system in accordance with claim 5, wherein said control device has additional keys in said keyboard, by means of which said setting means and other functions can likewise be selected.

7. A control device in accordance with claim 2, wherein speech commands have priority over key signals.

8. A control system in accordance with claim 1, wherein a diagnosis can be requested by means of an acoustic switching command.

9. A control system in accordance with claim 1, wherein a “stand-by” function is provided, which is preset when said control device is being activated.

10. A control system in accordance with claim 1, wherein at least one of said motor drives is connected to said control device by means of two relays.

11. A control system in accordance with claim 1, wherein at least one of said motor drives is short-circuited in a resting state.

12. A vehicle seat and control device system comprising:
one or more settable seat components;
a control device;
one or more setting means for setting a state of said seat components wherein each setting means has a motor drive connected to said control device, each said motor drive for setting the state of at least one of said seat components;
an acoustic control element connected to said control device for operation by an occupant of the vehicle seat for selecting a certain one of said setting means or selecting another function; and p1 a manual control element connected to said control device for operation by an occupant of the vehicle seat for at least one of actuating said motor drive of the selected setting means and executing said another selected function.

13. A vehicle seat and control device system in accordance with claim 12, wherein said acoustic control element comprises a speech recognition system, which receives and recognizes speech commands and acoustically acknowledges the speech commands received.

14. A vehicle seat and control device system in accordance with claim 12, wherein said acoustic control element comprising software and/or hardware integrated in said control device.

15. A vehicle seat and control device system in accordance with claim 12, wherein said manual control element is designed as a keyboard comprising two keys and additional keys by means of which one of said setting means and other functions can be selected.

16. A vehicle seat and control device system in accordance with claim 15, wherein speech commands have priority over key signals.

17. A vehicle seat and control device system in accordance with claim 12, wherein a diagnosis can be requested by means of the acoustic switching command.

18. A vehicle seat and control device system in accordance with claim 12, wherein a stand-by function is provided, which is preset when said control device is being activated.

19. A vehicle seat and control device system in accordance with claim 12, wherein at least one of said motor drives is connected to said control device by means of two relays.

20. A vehicle seat and control device system in accordance with claim 12, wherein at least one of said motor drives is short-circuited in a resting state.
